(19) United States
(12) Patent Application Publication
(10) Pub. No.: US 2006/0121393 A1
(43) Pub. Date: Jun. 8, 2006

(54) Green sheet and method of manufacturing the same, and a method of manufacturing a plasma display panel

(75) Inventors: Eun A. Moon, Seoul (KR); Min Soo Park, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/293,267

(22) Filed: Dec. 5, 2005

(30) Foreign Application Priority Data
Dec. 8, 2004 (KR) 10-2004-0103275

(51) Int. Cl. G03C 5/00

(52) U.S. Cl. 430/311; 445/24; 430/312

(57) ABSTRACT

The present invention relates to a green sheet and method of manufacturing the same, and a method of manufacturing a plasma display panel. According to the present invention, a black matrix layer and an electrode layer are formed on a substrate at the same time by once laminating a film in which the black matrix layer and the electrode layer are formed. In accordance with a method of manufacturing a plasma display panel according to the present invention, the number of a lamination process can be reduced, the consumption of a base film and a cover film can be reduced, and a possibility that fail may occur during a lamination process can be reduced.

This Nonprovisional application claims priority under 35 U.S.C. § 119(a) on Patent Application No. 10-2004-0103275 filed in Korea on Dec. 8, 2005 the entire contents of which are hereby incorporated by reference.

### BACKGROUND OF THE INVENTION

1. Field of the Invention

The present invention relates to a green sheet and method of manufacturing the same, and a method of manufacturing a plasma display panel.

2. Description of the Background Art

A plasma display panel in the related art is a kind of a light-emitting device that displays images using an inter-electrode gas discharge phenomenon between two sheets of glass substrates. A general plasma display panel does not need an active element for driving each cell. Therefore, the plasma display panel has a simple manufacturing process and a fast response speed and can also have a large size screen.

The plasma display panel of the related art comprises a front substrate and a rear substrate. In the front substrate are formed scan electrodes and sustain electrodes for a sustain discharge. In the rear substrate are formed address electrodes for an address discharge. In the manufacturing process of the plasma display panel in the related art, a screen printing method has been employed a lot in order to form the electrodes in the front substrate or the rear substrate. However, a method of forming electrodes using a dry film has recently been proposed instead of the screen printing method.

In the method of forming electrodes using the dry film, a thickness of electrodes can be made uniform, a large size screen is facilitated and a dry process is not required. The method of forming electrodes using the dry film is also advantageous in that process expenses and equipment maintenance expenses are low since a laminator is used.

FIG. 1 shows a method of manufacturing a plasma display panel in the related art. As shown in FIG. 1, in the method of manufacturing the plasma display panel in the related art, a predetermined pattern is formed in a transparent electrode material deposited on a substrate 100 using a photosensitive photoresist. The transparent electrode material is etched along the pattern to form transparent electrodes 101.

A Black matrix (black matrix) layer 102 is formed on the transparent electrodes 101 through laminating or screen-printing of a black matrix film or a photosensitive black paste. At this time, in the case where the black matrix film is part of a green sheet, a cover film and a base film of the green sheet are removed in order to laminate the black matrix film.

After the black matrix layer 102 is exposed along the predetermined pattern using black matrix masks 20, an electrode layer 103 is formed on the exposed black matrix layer 102 by laminating or screen-printing the electrode film or the photosensitive electrode paste. In this case, where the electrode film is part of a green sheet, a cover film and a base film of the green sheet are removed in order to laminate the electrode film.

After the electrode layer 103 is exposed along the electrode pattern using the electrode masks 30, the electrode layer 103 and the black matrix layer 102 are developed at the same time by the same developer, thereby forming an electrode 103′ and a black matrix 102′. The electrode 103′ and the black matrix 102′ are sintered in a sintering furnace at high temperature.

That is, the black matrix film or the photosensitive black paste is coated on the transparent electrodes through laminating or screen printing, and the black matrix film or the photosensitive black paste is then exposed along a desired pattern. The electrode film or the photosensitive electrode paste is exposed on the black matrix film or the photosensitive black paste along a desired pattern by laminating or screen-printing. Thereafter, the black matrix film or the photosensitive black paste, or the electrode film or the photosensitive electrode paste is developed at the same time, forming the black matrix 102′ and the electrode 103′.

In the case where an electrode or a black matrix is formed using a dry film such as an electrode film or a black matrix film in the related art, however, the lamination process must be performed twice in order to laminate the black matrix film and the electrode film. This increases the number of a manufacturing process.

Furthermore, since the lamination process is performed twice, a possibility that fail may be generated during the lamination process is increased.

Furthermore, since the lamination process must be performed twice, the amount of a base film and a cover film, which are removed, is increased, resulting in an increased manufacturing cost.

### SUMMARY OF THE INVENTION

Accordingly, an object of the present invention is to solve at least the problems and disadvantages of the background art.

The present invention provides a green sheet and method of manufacturing the same, and a method of manufacturing a plasma display panel, in which the number of al lamination process can be reduced.

The present invention provides a green sheet and method of manufacturing the same, and a method of manufacturing a plasma display panel, in which fail can be reduced during the lamination process.

The present invention provides a green sheet and method of manufacturing the same, and a method of manufacturing a plasma display panel, in which the amount of a base film and a cover film, which are consumed in the lamination process, can be reduced.

A method of manufacturing a plasma display panel according to an aspect of the present invention comprises the steps of laminating a film comprising a black matrix layer and an electrode layer stacked on the black matrix, on a substrate, forming an electrode by developing the electrode layer along a first pattern using a first developer, exposing the black matrix layer along a second pattern, and developing the black matrix layer along the second pattern using a second developer, thus forming a black matrix.

A green sheet according to an aspect of the present invention comprises a first film, a first layer which is exposed, laminated on the first film, a second layer laminated on the first layer, and a second film laminated on the second layer.

A method of manufacturing a green sheet according to an aspect of the present invention comprises the steps of reparing a first film, stacking a first layer on the first film, exposing the first layer, stacking a second layer on the first layer and stacking a second film on the second layer.

A method of manufacturing a plasma display panel according to the present invention can reduce the number of a lamination process.

A method of manufacturing a plasma display panel according to the present invention can reduce the consumption of a base film and a cover film since the number of a lamination process is reduced.

A method of manufacturing a plasma display panel according to the present invention can reduce a possibility that fail may occur during a lamination process since the number of the lamination process is reduced.

### BRIEF DESCRIPTION OF THE DRAWINGS

The invention will be described in detail with reference to the following drawings in which like numerals refer to like elements.

FIG. 1 shows a method of manufacturing a plasma display panel in the related art;

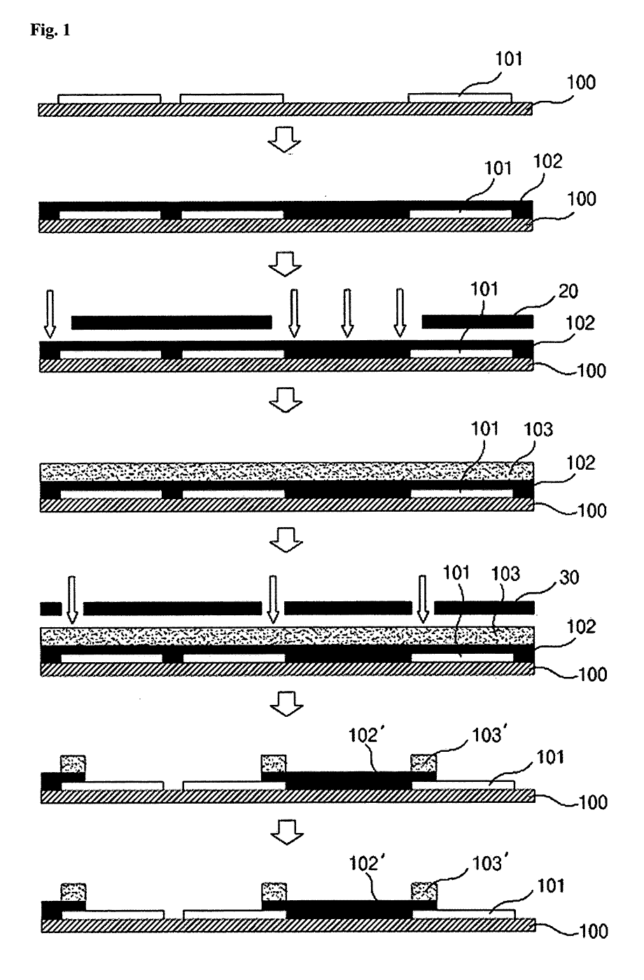

FIG. 2 shows a method of manufacturing a plasma display panel according to an embodiment of the present invention; and

FIG. 3 shows a method of manufacturing a green sheet according to an embodiment of the present invention.

### DETAILED DESCRIPTION OF PREFERRED EMBODIMENTS

Preferred embodiments of the present invention will be described in a more detailed manner with reference to the drawings.

A method of manufacturing a plasma display panel according to an aspect of the present invention comprises the steps of laminating a film comprising a black matrix layer and an electrode layer stacked on the black matrix, on a substrate, forming an electrode by developing the electrode layer along a first pattern using a first developer, exposing the black matrix layer along a second pattern, and developing the black matrix layer along the second pattern using a second developer, thus forming a black matrix.

The black matrix layer of the film may be exposed.

An amount of light to which the Black matrix layer of the film may be previously exposed is more than 100 millijoule/cm² to less than 200 millijoule/cm², and an amount of light to which the Black matrix layer may be exposed along the second pattern is more than 300 millijoule/cm² to less than 400 millijoule/cm² .

An amount of light to which the Black matrix layer of the film is exposed may be more than 20% to less than 40% of the entire exposure amount, and an amount of light to which the Black matrix layer may be exposed along the second pattern is more than 60% to less than 80% of an entire exposure amount.

The first developer and the second developer may be sodium carbonate, and the concentration of the first developer may be more than twice to less than three times of the concentration of the second developer.

The molecular weight of a binder contained in the black matrix layer may be more than 50,000 g/mol to less than 200,000 g/mol, the first developer and the second developer may be sodium carbonate, and the concentration of the first developer may be more than 0.3% to less than 1% and the concentration of the second developer is more than 0.6% to less than 3%.

The method further may comprise the step of removing a cover film and a base film for protecting the film.

A green sheet according to an aspect of the present invention comprises a first film, a first layer which is exposed, laminated on the first film, a second layer laminated on the first layer, and a second film laminated on the second layer.

The first layer may be a black matrix layer.

The second layer may be an electrode layer.

An amount of light to which the first layer is exposed may be more than 100 millijoule/cm² to less than 200 millijoule/cm².

An amount of light to which the first layer is exposed may be more than 20% to less than 40% of an entire exposure amount.

The molecular weight of a binder contained in the Black matrix layer may be more than 50,000 g/mol to less than 200,000 g/mol.

A method of manufacturing a green sheet according to an aspect of the present invention comprises the steps of reparing a first film, stacking a first layer on the first film, exposing the first layer, stacking a second layer on the first layer and stacking a second film on the second layer.

The first layer may be a black matrix layer.

The second layer may be an electrode layer.

An amount of light to which the first layer is exposed may be more than 100 millijoule/cm² to less than 200 millijoule/cm².

An amount of light to which the first layer is exposed may be more than 20% to less than 40% of the entire exposure amount.

The molecular weight of a binder contained in the black matrix layer may be more than 50,000 g/mol to less than 200,000 g/mol.

A detail embodiment of the present invention will be described with reference to the accompanying drawings.

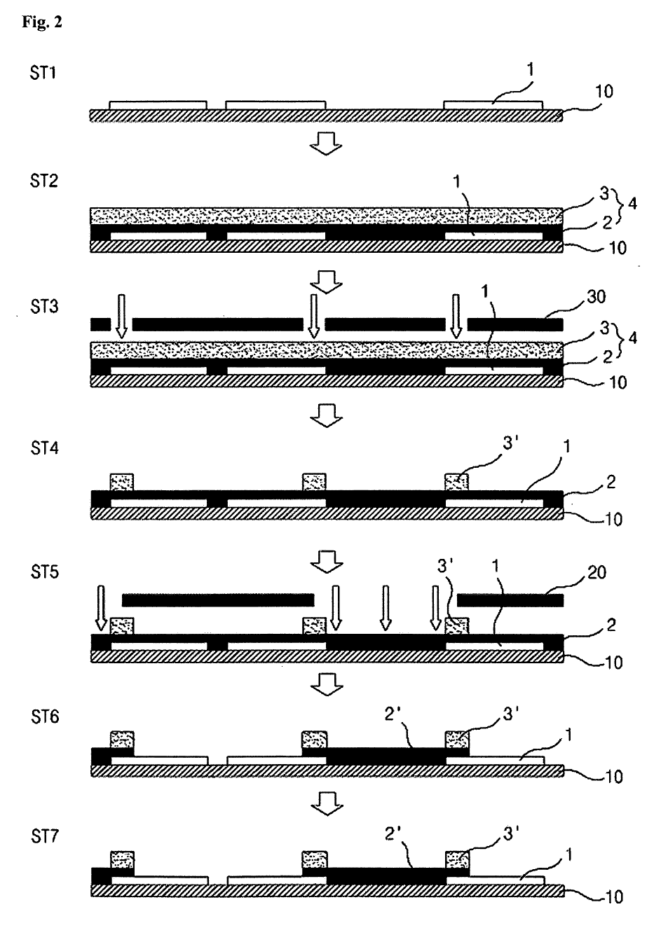

FIG. 2 shows a method of manufacturing a plasma display panel according to an embodiment of the present invention.

In a first step (ST1), a transparent electrode material is coated on a substrate 10. A transparent electrode material is then exposed along a transparent electrode pattern using a photosensitive resist and then developed, thus forming transparent electrodes 1.

In a second step (ST2), a dry film 4 comprising a photosensitive black matrix layer 2 and a photosensitive bus electrode layer 3 stacked on the photosensitive black matrix layer 2, is laminated on the transparent electrodes 1 through once lamination process. In this process, a cover film and a base film for protecting the dry film 4 are removed. The photosensitive black matrix layer 2 is brought in contact with the transparent electrodes 1 and the photosensitive bus electrode layer 3 is located on the photosensitive black matrix layer 2. That is, in the conventional method of manufacturing the plasma display panel, the lamination process must be performed twice because the electrode film and the black matrix film must be laminated separately. In the method of manufacturing the plasma display panel according to the present invention, however, only once lamination process needs to be performed because the dry film 4 having the photosensitive bus electrode layer 3 and the photosensitive black matrix layer 2 integrated therein is used. Therefore, the number of the manufacturing process of the plasma display panel can be reduced.

In a third step (ST3), the photosensitive bus electrode layer 3 is exposed along the electrode pattern of the electrode masks 30.

In a fourth step (ST4), a developing process using a developer is performed on the photosensitive bus electrode layer 3. A bus electrode 3′ having the electrode pattern is formed on the photosensitive black matrix layer 2 through the development process.

In a fifth step (ST5), the photosensitive black matrix layer 2 is exposed to a light such as an ultraviolet light along the black matrix pattern of black matrix masks 20.

In a sixth step (ST6), a developing process in which a developer is used, is performed on the photosensitive black matrix layer 2. A black matrix 2′ having the black matrix pattern is formed on the substrate 10 through the development process on the photosensitive black matrix layer 2.

In a seventh step (ST7), the substrate 10 in which the black matrix 2′ and the bus electrodes 3′ are formed is inserted into a sintering furnace and then sintered.

Meanwhile, two kinds of methods are proposed in order to prevent the photosensitive electrode layer 3 and the photosensitive black matrix layer 2 from being formed at the same time in the fourth step (ST4).

The first method is to make the concentrations of the electrode developer used in the fourth step (ST4) and the black matrix developer used in the sixth step (ST6) different from each other. That is, most of the electrode developer and the black matrix developer is a solution in which sodium carbonate (NaCO₃) of 3% or less is dissolved in pure water. A sodium carbonate solution having a concentration ranging from 0.3% to 1% is usually used. Therefore, the concentration of sodium carbonate used as the electrode developer is more than 0.3 to less than 1%, and the concentration of sodium carbonate used as the black matrix developer is more than 0.6% to less than 3%, which is from twice to three times of the concentration of sodium carbonate used as the electrode developer.

At this time, the molecular weight of a binder contained in a conventional black matrix layer, is more than 10,000 g/mol to less than 30,000 g/mol. The molecular weight of a binder of the photosensitive black matrix layer 2 used in the present invention is more than 50,000 g/mol to less than 200,000 g/mol. If the molecular weight of the binder is more than 50,000 g/mol to less than 200,000 g/mol, the binder is not developed by sodium carbonate having a concentration of more than 0.3% to less than 1%. Therefore, in the fourth step (ST4), the photosensitive black matrix layer 2 comprising the binder of which the molecular weight is more than 50,000 g/mol to less than 200,000 g/mol, is not developed by the sodium carbonate whose concentration is more than 0.3% to less than 1%, but only the photosensitive bus electrode layer 3 is developed.

Therefore, this problem can be solved by controlling a developing intensity of the photosensitive bus electrode layer 3 and the photosensitive black matrix layer 2 constituting the dry film 4.

The second method is to use a photosensitive black matrix layer that is exposed by some degree.

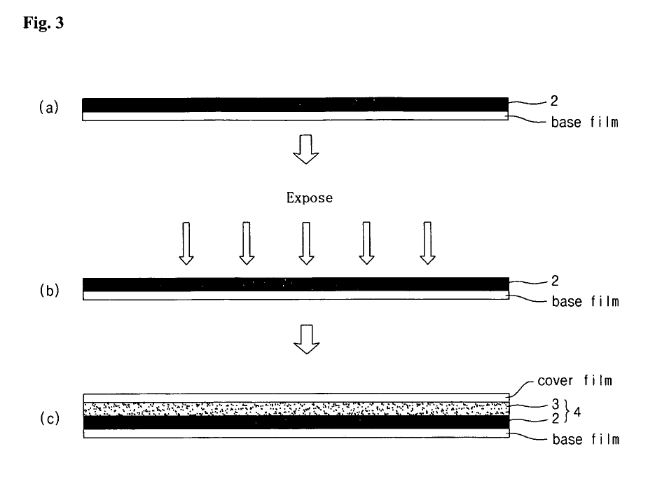

FIG. 3 shows a method of manufacturing a green sheet according to an embodiment of the present invention.

As shown in FIG. 3(a), a photosensitive black matrix layer 2 is formed on a base film.

As shown in FIG. 3(b), before a photosensitive bus electrode layer 3 is formed on the photosensitive black matrix layer 2, some degree of exposure is performed on the photosensitive black matrix layer 2. Therefore, some of a material within the photosensitive black matrix layer 2 reacts on ultraviolet rays used in the exposure process.

As shown in FIG. 3(c), the photosensitive bus electrode layer 3 is formed on the photosensitive black matrix layer 2 on which some degree of exposure has been performed. A cover film is formed on the photosensitive bus electrode layer 3 in order to form a dry film 4 consisting of the photosensitive black matrix layer 2 and the photosensitive bus electrode layer 3.

Therefore, when the photosensitive bus electrode layer 3 is developed by the developer in the fourth step (ST4) of FIG. 2, the photosensitive black matrix layer 2 that has been previously exposed can stand the developer.

For example, in the case where the entire exposure amount necessary to develop the photosensitive black matrix layer 2 is 500 millijoule/cm², if ultraviolet rays corresponding to more than 100 millijoule/cm² to less than 200 millijoule/cm², which is more than 20% to less than 40% of the entire exposure amount, are irradiated on the entire photosensitive black matrix layer 2 in the manufacturing process of the dry film, the photosensitive black matrix layer 2 can stand the developer for a predetermined time in the fourth step of FIG. 2 because a top surface of the photosensitive black matrix layer 2 has been previously exposed. Thereafter, if ultraviolet rays corresponding to more than 300 millijoule/cm² to less than 400 millijoule/cm², which is more than 60% to less than 80% of the entire exposure amount, are irradiated on the entire photosensitive black matrix layer 2 in the exposure step (ST5) of the photosensitive black matrix layer 2, some of the photosensitive black matrix layer 2, which are short of exposure due to the black matrix masks 20, are developed in the black matrix development step (ST6), and other portions of the photosensitive black matrix layer 2 on which the entire exposure amount has been irradiated remains intact.

In the method of manufacturing the plasma display device in the related art, the lamination process for performing the electrode layer and the black matrix layer is performed twice. In the method of manufacturing the plasma display device according to the present invention, however, the lamination process is performed only once because the dry film 4 in which the photosensitive bus electrode layer 3 and the photosensitive black matrix layer 2 are integrated is used.

Therefore, since the amount of a base film and a cover film consumed in the lamination process can be reduced by half as described above, the manufacturing cost can be saved.

Furthermore, a possibility that fail may occur during the lamination process is relatively reduced since the number of the lamination process is reduced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of manufacturing a plasma display panel, comprising the steps of:
laminating a film comprising a black matrix layer and an electrode layer stacked on the black matrix, on a substrate;
forming an electrode by developing the electrode layer along a first pattern using a first developer;
exposing the black matrix layer along a second pattern; and
developing the Black matrix layer along the second pattern using a second developer, thus forming a black matrix.

2. The method as claimed in claim 1, wherein the Black matrix layer of the film is exposed.

3. The method as claimed in claim 2, wherein an amount of light to which the Black matrix layer of the film is previously exposed is more than 100 millijoule/cm² to less than 200 millijoule/cm², and
an amount of light to which the Black matrix layer is exposed along the second pattern is more than 300 millijoule/cm² to less than 400 millijoule/cm².

4. The method as claimed in claim 2, wherein an amount of light to which the Black matrix layer of the film is exposed is more than 20% to less than 40% of the entire exposure amount, and
an amount of light to which the Black matrix layer is exposed along the second pattern is more than 60% to less than 80% of an entire exposure amount.

5. The method as claimed in claim 1, wherein the first developer and the second developer are sodium carbonate, and
the concentration of the first developer is more than twice to less than three times of the concentration of the second developer.

6. The method as claimed in claim 1, wherein the molecular weight of a binder contained in the black matrix layer is more than 50,000g/mol to less than 200,000g/mol,
the first developer and the second developer are sodium carbonate, and
the concentration of the first developer is more than 0.3% to less than 1% and the concentration of the second developer is more than 0.6% to less than 3%.

7. The method as claimed in claim 1, further comprising the step of removing a cover film and a base film for protecting the film.

8. A green sheet comprising:
a first film;
a first layer which is exposed, laminated on the first film;
a second layer laminated on the first layer; and
a second film laminated on the second layer.

9. The green sheet as claimed in claim 8, wherein the first layer is a black matrix layer.

10. The green sheet as claimed in claim 8, wherein the second layer is an electrode layer.

11. The green sheet as claimed in claim 8, wherein an amount of light to which the first layer is exposed is more than 100 millijoule/cm² to less than 200 millijoule/cm².

12. The green sheet as claimed in claim 8, wherein an amount of light to which the first layer is exposed is more than 20% to less than 40% of an entire exposure amount.

13. The green sheet as claimed in claim 9, wherein the molecular weight of a binder contained in the Black matrix layer is more than 50,000 g/mol to less than 200,000 g/mol.

14. A method of manufacturing a green sheet, comprising the steps of:
preparing a first film;
stacking a first layer on the first film;
exposing the first layer;
stacking a second layer on the first layer; and
stacking a second film on the second layer.

15. The method as claimed in claim 14, wherein the first layer is a Black matrix layer.

16. The method as claimed in claim 14, wherein the second layer is an electrode layer.

17. The method as claimed in claim 14, wherein an amount of light to which the first layer is exposed is more than 100 millijoule/cm² to less than 200 millijoule/cm².

18. The method as claimed in claim 14, wherein an amount of light to which the first layer is exposed is more than 20% to less than 40% of the entire exposure amount.

19. The method as claimed in claim 15, wherein the molecular weight of a binder contained in the black matrix layer is more than 50,000 g/mol to less than 200,000 g/mol.
